(19) United States
(12) Patent Application Publication
(10) Pub. No.: US 2008/0309171 A1
(43) Pub. Date: Dec. 18, 2008

(54) Linear Transverse Flux Machine

(75) Inventor: Chandur Sadarangani, Vasteras (SE)

Correspondence Address: VENABLE LLP, P.O. BOX 34385, WASHINGTON, DC, 20043-9998, US

(73) Assignee: ABB Research Ltd., Zurich (CH)

(21) Appl. No.: 11/667,550

(22) PCT Filed: Nov. 11, 2004
(86) PCT No.: PCT/SE04/01648

§ 371 Date: Nov. 19, 2007

(51) Int. Cl. H02K 41/03

(52) U.S. Cl. 310/15

(57) ABSTRACT

A transverse flux linear machine including a first interacting part including an electric winding and a second interacting part including a plurality of magnetic poles. The first and second interacting parts are movable relative to each other and defining between them an airgap.

### TECHNICAL FIELD

The present invention concerns a transverse flux machine. More precisely the invention concerns a machine and a method for accomplishing a linear movement with a transverse flux operation. Especially the invention concerns a transverse flux machine comprising a first and second interacting part, which are movable relatively to each other. The first part comprises an electric winding and the second part comprises a plurality of magnetic poles. The first part is often known as a stator and the second part is known as a translator. In the following text such a machine is denoted a transverse flux linear machine.

### BACKGROUND OF THE INVENTION

In a conventional electric machine the plane of the magnetic flux is aligned with the plane of movement while the plane of current is perpendicular to both of these planes. In a transverse flux machine the plane of current is aligned with the plane of movement while the plane of the magnetic flux is perpendicular to both of these planes. Most transverse flux machines use permanent magnets on a movable part and windings on a stationary part. Widely known is also the use of magnetizable cores to concentrate the magnetic flux.

Transverse flux machines are favorable for achieving a high torque density between the stationary part and the movable part. However, transverse flux machines are generally considered as difficult to manufacture and because of their complicated structure too expensive.

A wide variety of different constructions are known in the prior art. Generally a plurality of permanent magnets is assembled in a line to form the movable part. In rotating machines this line is in the form of a cylindrical body. Often these permanent magnets must be glued to the movable part. The electromagnetic circuit is then formed from a winding and a core. The core is made of a magnetizable material such as soft iron or a soft magnetic composite. In many known embodiments of TFPM machines these cores have to be constructed of a plurality of parts.

Among known embodiments of transverse flux machines there are at least four distinctive types. There is the double-sided, double-winding TFPM machine which has a first winding and a first U-shaped core on one side of the movable part, and a second winding and a second U-shaped core on the opposite side of the movable part. There is the double sided, single-wound TFPM machine which is the same as the previous machine but with only one winding and a U-formed core on both sides of the movable part. These designs are known as U-Core arrangement where the movable part is sandwiched between the two U-formed cores. Both of these machines involve a plurality of core parts that must be aligned and built around the movable part. This design leads to thicker air gaps due to deformations in the construction of the movable part.

From U.S. Pat. No. 5,973,436 (Mitcham) an electric machine is previously known. The object of this transverse flux machine is to reduce the amount of electromagnetic couplings. This machine represents the double-sided, single-wound machine with a C-core arrangement. Thus this machine has a core arrangement which is clamped around the edge of the movable part. In this design the number of magnets is halved but also half the air gaps are removed. Expectedly the torque density of this design is roughly half the torque density of the U-Core version.

From U.S. Pat. No. 5,633,551 (Weh) a machine with transverse flux is previously known. The object of the machine is to improve the effectiveness of the exciter members and to simplify manufacture. This machine is known as the E-Core configuration. Thus, the core has two windings and an E-shaped core. The movable part comprises two lines of assembled permanent magnets. In the embodiment disclosed, the movable part comprises two concentric cylindrical shells. In production, however, there will be difficulty in forming and assembling an E-shaped core between the two windings. Also this machine has four air gaps and the risk of even thicker air gaps is obvious. A variety of the E-core construction is previously known from U.S. Pat. No. 6,717,297 (Sadarangani).

Finally there is the single sided, single-wound machine. In a first embodiment this machine is a clawpole transverse flux machine. The movable part comprises a single row of magnetic poles. In a first embodiment each pole comprises an open permanent magnet with its flux orientation perpendicular to the movement. Every second magnet is oriented in antiparallel with the adjacent magnets. In a second embodiment each pole comprises a flux concentrator in the form of a soft iron piece and a permanent magnet on each side. This is known as the buried magnets arrangement. Each of the two magnets has a flux orientation in parallel with the movement but in antiparallel with each other. Thus the flux of the two magnets is concentrated in the soft iron piece between the two magnets and directed perpendicular to the movement of the movable part. Every soft iron piece thus forms a pole with the magnetic flux interacting with the magnetic flux of the stationary part. The stationary part in this machine comprises a plurality of claw-shaped cores and a winding aligned in the direction of the movement of the movable part. Each core is wound around the winding and comprises a first and second outer tip in an overlap joint, such that the first tip is oriented in parallel with the second tip but separated by one pole distance in the direction of the movement.

In a second embodiment of the single sided, single-wound machine the movable part comprises first and second parallel rows of poles. Each pole may comprise a permanent magnet or an arrangement with a flux concentrator and two buried permanent magnets as described above. Each row comprises a plurality of poles every second of which with its magnetic flux oriented perpendicular to the movement but antiparallel to each other. The first row of poles is displaced one pole distance in the direction of the movement such that in a cross section perpendicular to the movement a pole in the first row has an opposite flux direction to a pole in the second row. The stationary part comprises in this embodiment a plurality of U-shaped core pieces and a winding aligned along the movement of the movable part.

Energized by the winding a first U-formed core piece forms an upper magnetic flux loop transverse to the movement. A lower flux loop is formed by a first and a second pole and a second U-formed core piece. In a first embodiment the first core piece is located in the stationary part and the second core piece located in the movable part. The magnetic flux loop thus comprises the first U-shaped core piece, a first pole in the first row of poles, the second U-shaped core piece, and a second pole in the second row of poles.

In a second embodiment the lower flux loop is shaped by a pair of adjacent poles in each row of poles and a second U-formed core piece placed in the stationary part. The first U-formed core piece is wound around the winding while the second core piece is not. The second core pieces are placed between the first core pieces and each second core piece passes under the winding from the first row of poles to the second row of poles. The magnetic flux loop thus comprises the first U-shaped core piece, a first pole in the first row of poles, an adjacent pole in the first row of poles, the second core piece, a second pole in the second row of poles and an adjacent pole in the second row of poles.

The single sided, single-wound transverse flux machine allows laminated steel to be used in the stationary part. The specific iron losses are then about seven times lower than nonlaminated steel. Thus a machine having a laminated core is far more efficient than a non-laminated core. One significant problem in single sided TFPM machines is the magnetic flux leakage between the stationary core and the core forming the return path of the magnetic flux. This leakage may however be reduced partly by the design of the cores and partly by making the permanent magnets and their concentrators longer than the fastening assembly. Although possible the cores cannot be placed too narrow in the direction of the movement because of flux leakage between the core pieces.

Even though the known transverse flux machines may be designed to be more efficient they still exhibit a plurality of parts that must be assembled in a manner demanding a great deal of manual work. Thus there is a need for a production friendly but still efficient transverse flux linear machine.

### SUMMARY OF THE INVENTION

A primary object of the present invention is to provide a transverse flux linear machine that offers a high torque density and at the same time provides a simple design. Yet another object is to provide a transverse flux linear machine comprising a standard lamination structure.

This object is achieved according to the invention by a transverse flux linear machine characterized by the features of the independent claim 1 or by a method characterized by the steps of the independent claim 12. Preferred embodiments are described in the dependent claims.

In a first aspect of the invention the transverse flux linear machine comprises a first interacting part comprising an electric winding and a second interacting part containing a plurality of magnetic poles. The two interacting parts are movable relative to each other and define between them an airgap. Further, when energized by the winding, the machine comprises a plurality of magnetic flux loops oriented in a plane perpendicular to the movement. A bundle of magnetic flux loops forms a leg portion crossing the airgap. The leg portion comprises a first leg part located in the first interacting part and a second leg part located in the second interacting part. The first leg part comprises an elongated magnetic flux conductor. The second leg part comprises a magnetic pole. The elongated magnetic flux conductor is surrounded by an electric coil for creating within the leg portion a magnetic flux interacting with the magnetic flux of the pole. The coil constitutes a part of the electric winding. The electric winding according to the invention is thus wound around the magnetic flux conductor instead of the magnetic flux conductor being wound around the winding as in prior art transverse flux machines.

The first interacting part of the transversal flux machine comprises a stator back and the second interacting part comprises a translator back. The stator back and the translator back are made of a magnetic flux conducting material. The stator back is magnetically connecting a plurality of elongated magnetic flux conductors in a direction perpendicular to the movement. The translator back is connecting a plurality of magnetic poles in a direction perpendicular to the movement. Thus, the magnetic flux in the stator back and in the translator back complete the magnetic flux loops in the machine.

In preferred embodiments of the invention the pole comprises an open permanent magnet or a buried permanent magnet arrangement. In a further embodiment the poles comprises electromagnets which are fed by a slip ring arrangement. In yet another embodiment of the invention the magnetic flux conductor comprises a tooth-shaped core of a magnetizable material. In yet another embodiment the core comprises a plurality of teeth combined with a flux conducting stator back in a line along the airgap and perpendicular to the movement. In yet another embodiment of the invention the poles of the first interacting part are arranged in parallel rows in the direction of the movement. Still in a further embodiment the poles of adjacent parallel rows are displaced in the direction of the movement such that the transverse flux linear machine is operable by a plurality of phases.

In a preferred embodiment the second interacting part comprises an elongated translator with a tubular cross section and the first interacting part comprises a stator surrounding the translator. The airgap in this embodiment is therefore cylindrical. A plurality of poles including permanent magnets is arranged in rows parallel to the axis of movement of the translator. A plurality of magnetizable teeth surrounded by coils is arranged in lines along the airgap and perpendicular to the axis of movement. In a further embodiment the airgap is circularly cylindrical. Every second pole in a row has a magnetic flux orientation opposite to the flux orientation of an adjacent pole in the row. Each pole in a row is separated from the next pole by a distance equal to the distance between two adjacent teeth in the direction of the movement. In a preferred development of this embodiment of the invention the movable part comprises two poles within a distance between a first edge of a first tooth and the first edge of a following tooth in the axis direction. In this embodiment the winding comprises electric coils that are wound around a plurality of teeth in the direction of the movement.

In yet a preferred embodiment of the invention the transverse flux machine comprises a multiphase machine. In this embodiment the poles of different rows are displaced evenly according to the number of phases. Thus for a three phase machine a pole of a row representing the second phase is displaced two third of the distance between two poles of the first row. Consequently a pole in a row representing the third phase is displaced four thirds of the distance between two poles of the first row. Different phases may be arranged in adjacent rows or may be distributed and mixed with the other phases. Thus for the three phase machine the displacement to accommodate between the phases represents 120 electrical degrees.

In yet a further embodiment of the invention the poles of the second interacting part comprises a Halbach arrangement of permanent magnets. A Halbach arrangement is characterized in providing a plurality of permanent magnets in a row where the flux orientation of two adjacent magnets is perpendicular or less. Thus in a first Halbach arrangement the flux orientation of five adjacent magnets in a row is 0, 45, 90, 135 and 180 degrees. In a second Halbach arrangement called a Quasi Halbach arrangement the flux orientation of three adjacent magnets are 0, 90 and 180 degrees. In a further embodiment the permanent magnets are provided with a translator back of a thin core piece of a magnetizable material. The embodiment of combining a Halbach arrangement with a magnetic flux conductor may be called a Hybrid Halbach arrangement.

In a second aspect of the invention the objects are achieved by a method for forming a magnetic flux between a first and second relatively movable interacting parts of a transverse flux machine separated by an airgap. The method comprises providing a plurality of transverse magnetic flux loops oriented in a plane perpendicular to the movement. Assembling a bundle of the magnetic flux loops to form a leg portion crossing the airgap, the leg portion having a first part located in the first interacting part and a second part located in the second interacting part. Further the method provides for the first leg part to comprise an elongated magnetic flux conductor and for the second leg part to comprise a magnetic pole. The method further provides a winding comprising an electric coil to be wound around the flux conductor for generating within the leg portion a magnetic flux interacting with the magnetic flux of the pole.

In a further embodiment of the method the elongated magnetic flux conductors are arranged as teeth with a magnetic flux conducting stator back and arranged in a line along the airgap the lines being oriented in a plane perpendicular to the movement. In yet a further embodiment of the invention the poles of the second interacting part are arranged in parallel rows along the direction of the movement.

### BRIEF DESCRIPTION OF THE DRAWINGS

Other features and advantages of the present invention will become more apparent to a person skilled in the art from the following detailed description in conjunction with the appended drawings in which:

FIG. 1 is a principle sketch of the difference between a conventional electric machine and a transverse flux machine,

FIG. 2 is a transverse flux machine according to the prior art,

FIG. 3 is a transverse flux machine according to the invention,

FIG. 4 is a second embodiment of a transverse flux machine according to the invention,

FIG. 5 is a third embodiment of a transverse flux machine according to the invention,

FIG. 6 is a cross section of a further embodiment of a transverse flux machine according to the invention,

FIG. 7 is a magnetic flux loop through the airgap of a transverse flux machine according to the invention,

FIG. 8 is a cross section of a three phase transverse flux machine according to the invention,

FIG. 9 is a longitudinal section of a transverse flux machine according to the invention,

FIG. 10 is a three dimensional view of a translator according to the invention,

FIG. 11 is s first embodiment of a multiphase transverse flux machine,

FIG. 12 is a second embodiment of a multiphase transverse flux machine,

FIG. 13 is a translator of a complete embodiment of a multiphase transverse flux machine,

FIG. 14 is a translator and a stator of the complete embodiment,

FIG. 15 is a translator, a stator and winding of the complete embodiment,

FIG. 16 is a translator of a second complete embodiment of a multiphase transverse flux machine,

FIG. 17 is a translator and a stator of the second complete embodiment, and

FIG. 18 is a translator, a stator and winding of the second complete embodiment of a multiphase transverse flux machine.

### DESCRIPTION OF PREFERRED EMBODIMENTS

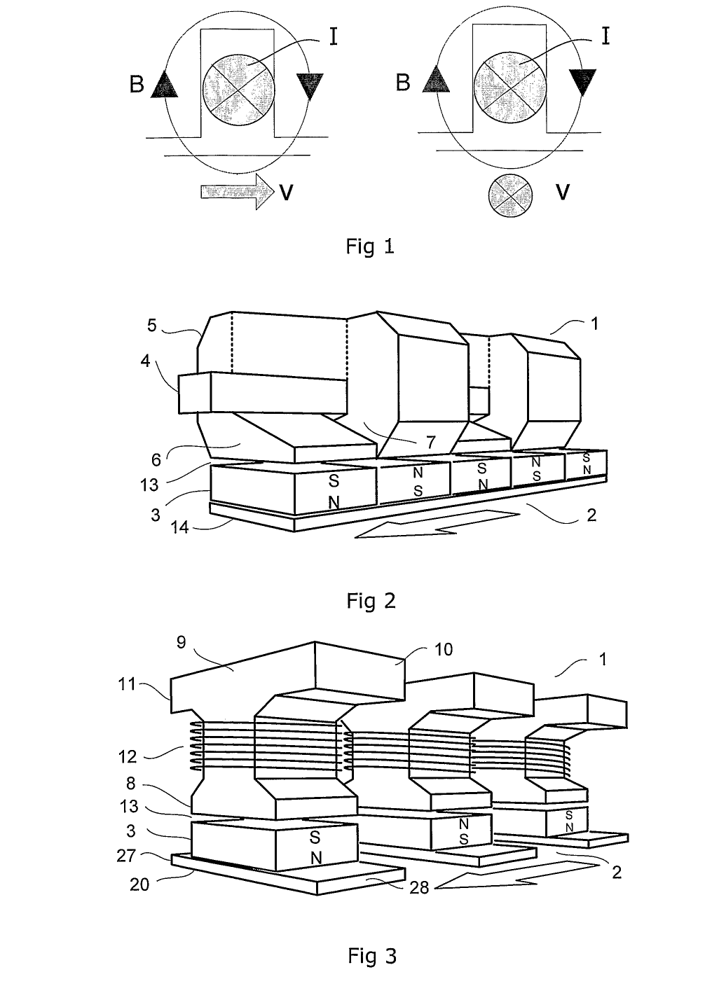

In a conventional electric machine the plane of the magnetic flux B is aligned with the plane of movement V while the plane of current I is perpendicular to both of these planes. This is shown in the left part of FIG. 1. In a transverse flux machine the plane of current I is aligned with the plane of movement V while the plane of the magnetic flux B is perpendicular to both of these planes. This is shown in the right part of FIG. 1.

A transverse flux machine according to the prior art is shown in FIG. 2. The machine comprises a stator part 1 and a translator part 2 movable in the direction of the arrow in the lower part of FIG. 2. The translator part comprises a plurality of permanent magnets 3 arranged in a row on a magnetic flux conducting translator back 14. The magnetic flux orientation of adjacent magnets is in antiparallel with each other. The stator comprises a winding 4 and a plurality of core pieces 5. The winding comprises a plurality of strands in a bundle aligned in the direction of the movement. The core pieces are formed of magnetizable sheet material. Each core piece comprises a claw-formed body 5 with a first tip 6 and a second tip 7 (mostly hidden). When energized by the winding the first and second tips of the same core piece are interacting with first and second adjacent magnets in the row. When energized by the winding a plurality of magnetic flux loops are formed, each of which comprising the claw-shaped core piece, a first magnet of a row, the translator back, and a second magnet in the same row. The magnetic flux loop thus formed has one part transverse to the direction of movement and a second part along the direction of movement.

A transverse flux linear machine with permanent magnets according to invention is shown in FIG. 3. The machine comprises a stator part 1 and a translator part 2 movable in the direction of the arrow shown in the lower part of FIG. 3. The stator part and the translator part are separated from each other by an airgap 13. The stator part comprises a plurality of teeth 8 arranged in a line in the direction of the movement. Each tooth is supported by a stator back 9 of a magnetically conducting material. An electric coil 12 for generating a magnetic flux in a direction perpendicular to the movement is wound around each tooth. The stator part in the figure is restricted to one line of teeth only. Thus the stator back 9 in the figure shows a first 10 and second 11 cut surface for indicating the integration of a plurality of teeth with a common stator back along the airgap and perpendicular to the movement. The direction of the magnetic flux of adjacent teeth in the line of movement is in antiparallel with each other when energized by the coils of winding.

The translator part comprises a plurality of poles 3 arranged in a row in the direction of the movement. Each pole comprises in the embodiment shown a permanent magnet. The magnetic flux orientation of adjacent magnets is in antiparallel with each other. Each magnet is supported by a translator back 20 of a magnetically conducting material. Like the stator back above the translator back in the figure shows a first cut surface 27 and a second cut surface 28 for indicating the integration of a plurality of translator backs into a common translator back along the airgap and perpendicular to the movement.

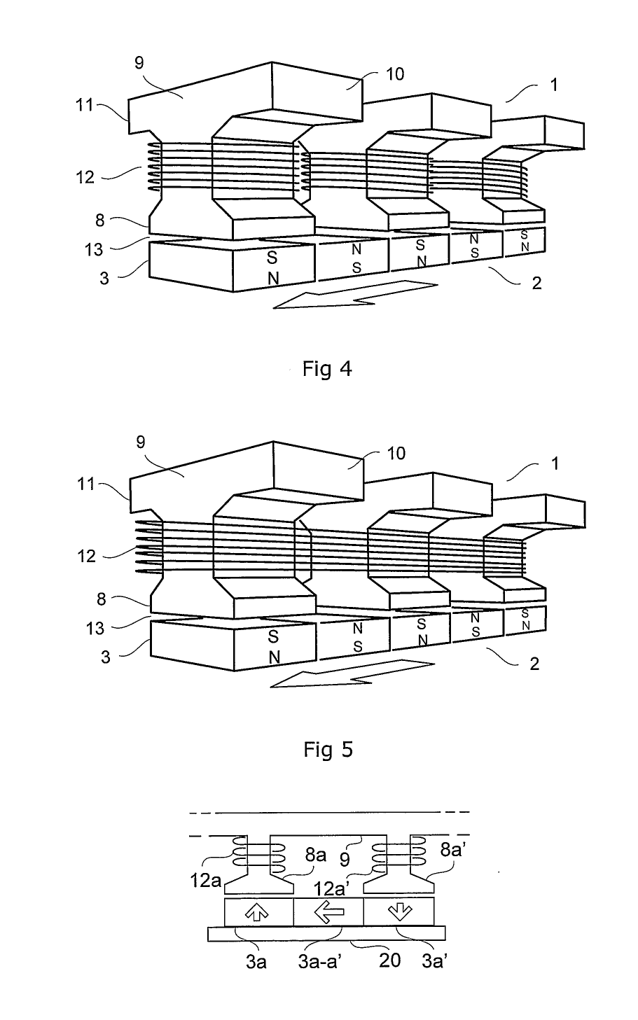

A second embodiment of the transverse flux machine according to the invention is shown in FIG. 4. The machine comprises a stator part 1 and a translator part 2 separated by an airgap 13. The stator part comprises a plurality of teeth 8, each surrounded by an electric coil 12. This is known as a local coil arrangement. In this embodiment all teeth along the row of poles have the same magnetic flux direction when energized by the winding. The flux direction changes by the direction of the current in the electric coils. In this embodiment there are twice as many poles as teeth in the direction of the movement. Every second pole in the row thus has a flux direction in parallel with each other but in antiparallel with the poles in between.

A further development of the transverse flux machine according to the invention is shown in FIG. 5. The machine comprises a stator part 1 and a translator part 2 separated by an airgap 13. The stator part comprises a plurality of teeth 8 arranged along the airgap. In fact this embodiment comprises the same teeth and poles arrangement as in the previous figure but the winding is different. According to the embodiment in FIG. 5 each coil surrounds a plurality of teeth. This is called a global winding and consequently all teeth within the coils have the same magnetic flux direction.

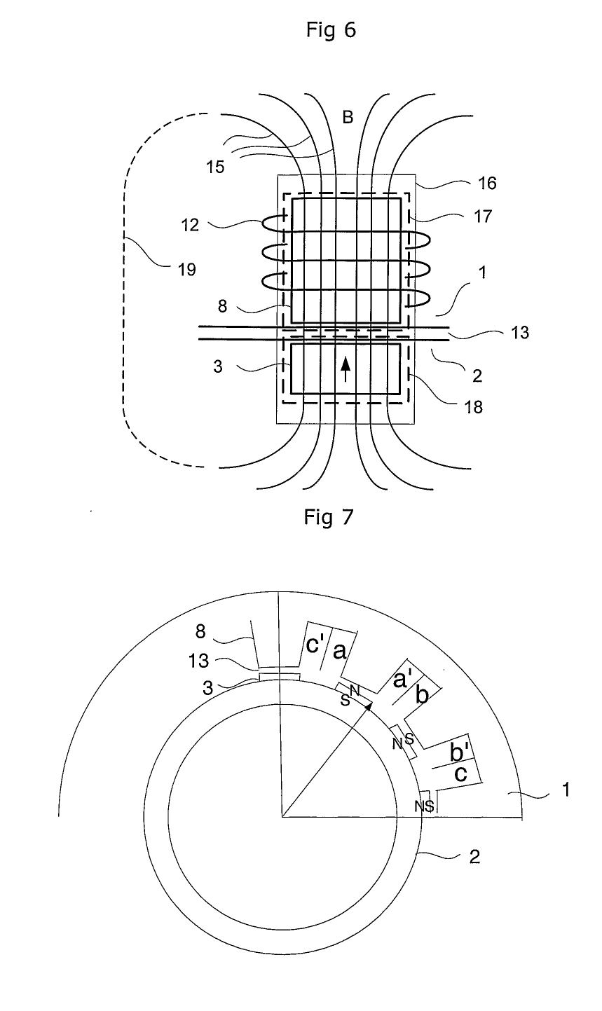

A cross section of a transverse flux machine is shown in FIG. 6. Thus the direction of movement is in and out of the paper plane. In the embodiment shown the magnets of the translator are positioned in a Halbach arrangement. In order to conduct the magnetic flux within a thin layer in the translator two opposite poles in adjacent rows are combined with a common magnetic element. Thus a first magnet 3a of a first row of magnets and a second magnet 3a′ of the second row of magnets are combined with a third permanent magnet 3a-a′ in between. When energized by a winding comprising a first coil 12a and a second coil 12a′ a magnetic flux loop is formed in a clockwise direction by the first magnet 3a, a first tooth 8a, the stator back 9, a second tooth 8a′, the second magnet 3a′ and the third magnet 3a-a′. In the embodiment shown a magnetic flux conductor 20 in the form of a piece of soft iron is placed behind the magnets. The magnet arrangement in the figure is called a Quasi Halbach arrangement. A Halbach arrangement may also comprise a plurality of magnets between the two pole magnets. Thus in a second Halbach arrangement the flux orientation of five adjacent magnets in a line is 0, 45, 90, 135 and 180 degrees.

The essence of the present invention is shown in FIG. 7. The transverse flux machine comprises a first interacting part 1 and the second interacting part 2 separated by an airgap 13. Further the machine comprises at least one magnetic flux loop 15 oriented in a plane perpendicular to the movement. Only a part of the loops are shown in the figure. A bundle of magnetic flux loops forms a leg portion 16 crossing the airgap 13. The leg portion comprises a first leg part 17 located in the first interacting part and a second leg part 18 located in the second interacting part. The first leg part 17 comprises a tooth part 8 of the core and the second leg part 18 comprises a magnetic pole 3 which in the embodiment shown is a permanent magnet. In an equivalent embodiment the pole comprises an electromagnet. The first interacting part comprises an electric coil 12 wound around each tooth 8.

Although not shown in FIG. 7 the first interacting part comprises a stator back and the second interacting part comprises a translator back for conducting the magnetic flux transverse to the direction of movement. Accordingly the loops are completed by a second leg 19 or a plurality of branched legs passing the airgap in the same plane perpendicular to the movement.

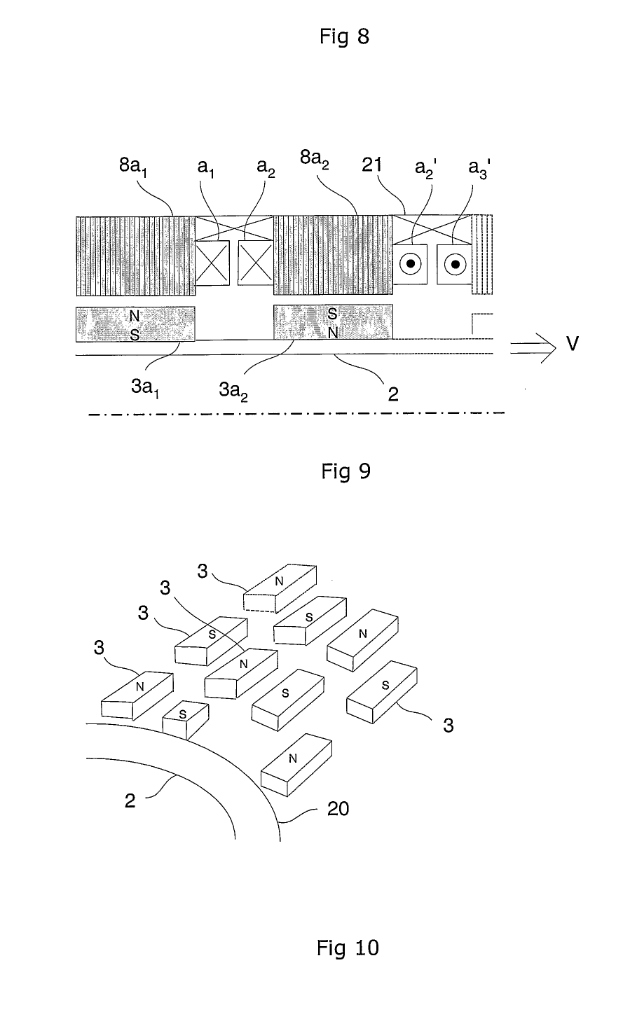

In FIG. 8 a section of a transverse flux machine according to the invention is shown. The machine comprises a stator 1 and a translator 2 defining between them an airgap 13. The translator has a tubular form and comprises a plurality of permanent magnets 3 attached to the surface of the translator. The translator is surrounded by the stator which comprises a plurality of teeth 8 and coils a, b, c, where each coil is wound around the tooth. Note that the direction of movement of the translator is perpendicular to the plane of the paper. The machine in FIG. 8 is a three phase machine with a first phase winding a-a′, a second phase winding b-b′ and a third phase winding c-c′. Letters a, b and c denote the ingoing part of the strands in the electric coil and a′ b′ and c′ denote the outgoing part of the coil. The embodiment shows one way to mix the windings.

A section along the axis of movement of a part of the transverse flux machine above is shown in FIG. 9. In the embodiment shown there is a first tooth 8a₁ interacting with a first magnet 3a₁ and a second tooth 8a₂ interacting with a second magnet 3a₂. Around each tooth there is a winding in the form of a coil a₁, a₂, a₃ wound around each tooth. Each magnet is attached to the translator 2 of the machine. In order to form separate magnetic loops in the transverse direction the teeth have to be separated from each other in the direction of movement. This has to be done also in the machines of the prior art. Normally this distance cannot fulfill any function and consequently it affects the efficiency of the machine. Thus, the lines of integrated teeth are separated by a member 21 that must have non-magnetic flux conducting capability. In the space formed between the two lines of teeth the winding is located.

Normally in the prior art the core pieces of each phase must be displaced in the direction of the movement. According to the invention the magnets are displaced instead. An outer surface of a translator according to the invention is shown in FIG. 10. The translator 2 comprises a translator back 20 on which a plurality of permanent magnets 3 is attached. One way of attaching the magnets is gluing. As can be seen from the figure the magnets are organized in rows but with the magnets displaced in the direction of movement.

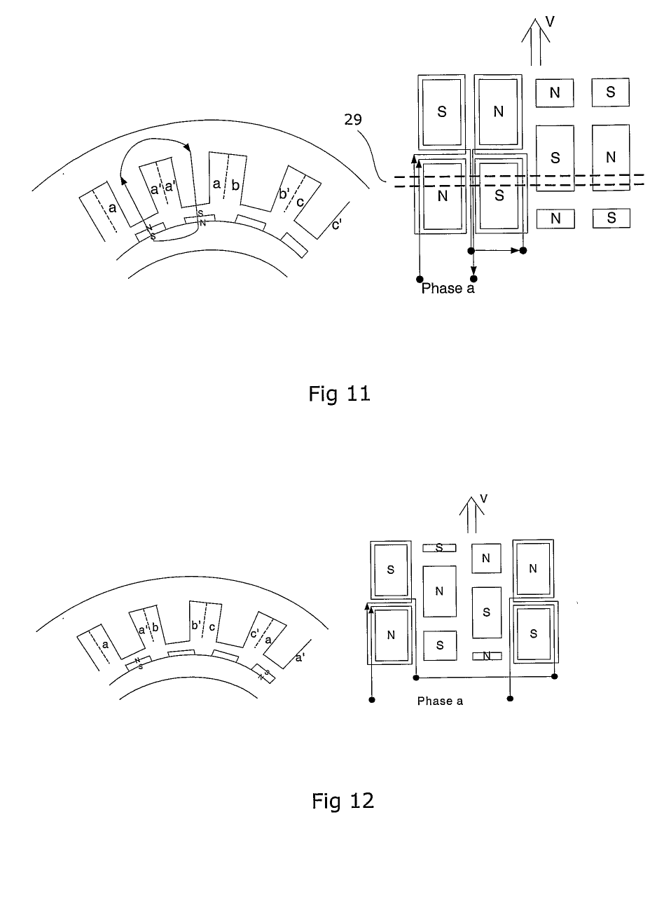

A first arrangement of a transverse flux machine with a plurality of phases is shown in FIG. 11. On the left side of the figure there is shown a section through the machine with a magnetic flux loop formed by the permanent magnets. On the right side is shown the arrangement of permanent magnets on the translator surface. It is thus evident that the phase windings of the machine may be mixed in a plurality of ways. The only restriction is that within a cross section of the geometry the sum of flux entering the stator from the translator through the airgap must be equal to the sum of flux leaving the stator to the translator through the airgap. Thus in a narrow slot window 29 oriented in the plane of the airgap must when passing over the magnets in the direction of the movement show an equal sum of magnet surfaces having its flux direction upwards from the paper and downwards into the paper respectively.

A second arrangement of a transverse flux machine with a plurality of phases is shown in FIG. 12. On the left side of the figure there is shown a section through the machine and on the right side is shown the arrangement of permanent magnets on the translator surface. Also in this embodiment it is important that an equal sum of magnet surfaces of the right hand side figure having its flux direction upwards from the paper and downwards into the paper respectively appear when moving a slot window over the magnets.

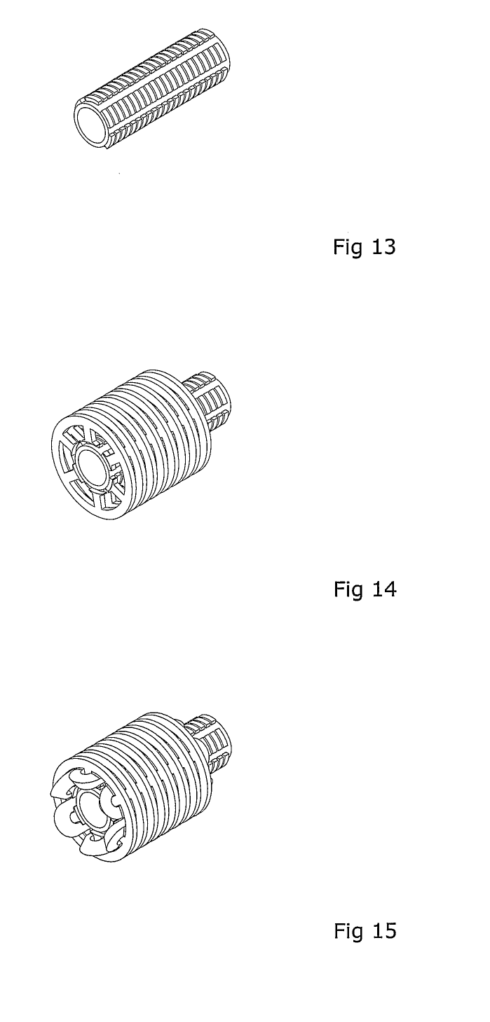

In FIGS. 13, 14 and 15 a complete transverse flux machine according to the invention is shown. FIG. 13 only shows the translator in which a plurality of permanent magnets is attached in rows with a line displacement to match a three phase machine. In FIG. 14 the translator and the stator are shown together and in FIG. 15 also the winding is attached. In the embodiment shown the winding comprises a plurality of global coils that surround a plurality of teeth in a line along the direction of the movement.

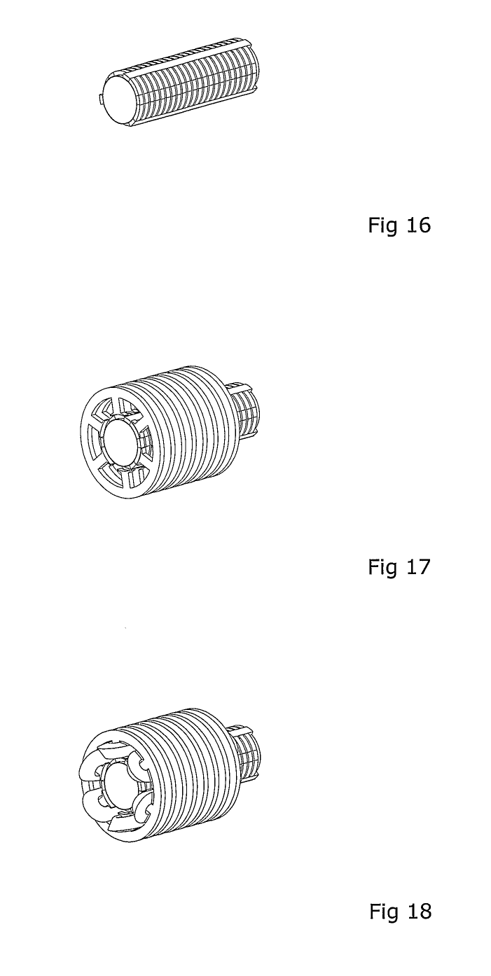

In FIGS. 16, 17 and 18 a complete transverse flux machine according to a second embodiment is shown. In FIG. 16 only the translator is shown. In the embodiment shown the pole arrangement comprises a plurality of permanent magnets in a Halbach arrangement. Thus, each magnet in a first row is connected to a second magnet in a second row along the movement of the translator by a connecting magnet, the flux orientation of which is perpendicular to the first and second magnets. By this arrangement, the magnetic flux is strengthened.

Although favorable the scope of the invention must not be limited by the embodiments presented but also contains embodiments obvious to a person skilled in the art. For instance the translator may comprise a tube protruding out of the stator and the ends of which comprise pistons of a combustion machine. Thus by driving such combustion machine the transverse flux machine is used as a generator.

The tubular translator may be provided from any suitable material such as metal or reinforced plastic. In order to minimize the weight the translator may be produced in a thin tube of titanium or carbon reinforced plastic.

In a further embodiment the inner space of the tubular translator may be used to house other equipment. Thus it may comprise electrical equipment as well as a shaft arrangement along which the translator is movable.

In yet a further embodiment the linear transverse flux machine may be used for producing electric power out of wave power. Thus the energy of waves at sea may be converted into electric power by arranging one of the interacting parts to be connected to the movement of the waves.

1. A transverse flux linear machine, comprising:
a first interacting part comprising an electric winding, and
a second interacting part comprising a plurality of magnetic poles, the first and second interacting parts being movable relative to each other and defining between them an airgap, wherein the machine, when energized by the winding, comprises a plurality of magnetic flux loops oriented in a plane perpendicular to the direction of the movement, wherein a bundle of magnetic flux loops forms a leg portion crossing the airgap, wherein the leg portion comprises a first leg part located in the first interacting part and a second leg part located in the second interacting part, wherein the first leg part comprises an elongated magnetic flux conductor, wherein the second leg part comprises one magnetic pole of the plurality of magnetic poles, and wherein the winding comprises an electric coil wound around the magnetic flux conductor.

2. The transverse flux linear machine according to claim 1, wherein the plurality of magnetic poles are arranged in a plurality of rows (3a, 3a′) in the direction of the movement.

3. The transverse flux linear machine according to claim 2, wherein a first pole in a first row is displaced in the direction of the movement in comparison with a second pole in a second row.

4. The transverse flux linear machine according to claim 1, wherein the poles comprise permanent magnets.

5. The transverse flux linear machine according to claim 4, wherein the second interacting part comprises a first magnet in a first row, a second magnet in a second row and at least one intermediate magnet between the first and second magnets to form a Halbach arrangement.

6. The transverse flux linear machine according to claim 1, wherein the second interacting part comprises a translator back for magnetically connecting the permanent magnets in lines perpendicular to the movement.

7. The transverse flux linear machine according to claim 1, wherein the first interacting part comprises a plurality of elongated magnetic flux conductors arranged in lines in a plane perpendicular to the movement.

8. The transverse flux linear machine according to claim 7, wherein the plurality of elongated magnetic flux conductors are integrated with each other by a stator back.

9. The transverse flux linear machine according to claim 7, wherein the elongated magnetic flux conductors and the stator back are made of a magnetizable sheet material.

10. The transverse flux linear machine according to claim 1, wherein the second interacting part comprises a tubular cross section.

11. The transverse flux linear machine according to claim 7, wherein the electric coil is wound around a plurality of teeth in the direction of the movement.

12. A method for forming a magnetic flux in a transverse magnetic flux linear machine comprising a first interacting part comprising an electric winding and a second interacting part comprising a plurality of magnetic poles, the first and second interacting parts being movable relative to each other and defining between them an airgap, the method comprising:
providing by energizing the winding a plurality of flux loops oriented in a plane perpendicular to the direction of the movement,
forming from a bundle of the flux loops a leg portion crossing the airgap, the leg portion comprising a first leg part located in the first interacting part and a second leg part located in the second interacting part,
providing the first leg part to contain an elongated magnetic flux conductor, providing the second leg part to contain a magnetic pole, and
winding a part of the electric winding around the flux conductor to form an electric coil for generating within the leg portion a magnetic flux interacting with the magnetic flux of the pole.

13. The method according to claim 12, wherein the magnetic poles are arranged in rows in the direction of the movement.

14. The method according to claim 12, wherein the plurality of elongated magnetic flux conductors are integrated with each other by a stator back and arranged in lines in a plane perpendicular to the movement.

15. Use of a transverse flux machine according to claim 1 for generating electric power from a combustion machine.

16. Use of a method according to claim 12 for generating electric power from a combustion machine.
